(19) United States
(12) Patent Application Publication
(10) Pub. No.: US 2014/0313327 A1
(43) Pub. Date: Oct. 23, 2014

(54) PROCESSING DEVICE, INTEGRATED CIRCUIT, PROCESSING METHOD, AND RECORDING MEDIUM

(71) Applicant: Panasonic Corporation, Osaka (JP)

(72) Inventor: Kinichi MOTOSAKA, Osaka (JP)

(73) Assignee: Panasonic Corporation, Osaka (JP)

(21) Appl. No.: 14/251,722

(22) Filed: Apr. 14, 2014

(30) Foreign Application Priority Data
Apr. 22, 2013 (JP) 2013-089026

(51) Int. Cl. H04N 7/18

(52) U.S. Cl. CPC H04N 7/181
USPC 348/143

(57) ABSTRACT

A processing device includes: an encoder configured to compression-encode first uncompressed information, based on a first parameter set, to generate first compression-encoded information, and to output the first compression-encoded information; a decoder configured to decode the first compression-encoded information to generate second uncompressed information, and to output the second uncompressed information; an image-and-sound processor configured to execute an attribute extraction process on the first uncompressed information to extract attribute information, and then to output first extracted attribute data which is the extracted attribute information, and to execute the attribute extraction process on the second uncompressed information to extract attribute information, and then to output second extracted attribute data which is the extracted attribute information; and a controller configured to determine, when the first extracted attribute data and the second extracted attribute data are identical, the first parameter set as an established parameter set.

### BACKGROUND OF THE INVENTION

1. Field of the Invention

The present disclosure relates to proxy processes of information.

2. Description of the Related Art

Conventionally, a system is known in which a mobile terminal requests an operation capability providing device to perform a proxy process (see Unexamined Japanese Patent Publication No. 2008-123344).

### SUMMARY OF THE INVENTION

However, in the above-mentioned conventional configuration, it is not referred to whether or not there is difference between the first attribute information (for example, the object's sex is male) extracted from information on which a proxy request source device has not performed a compression-encoding process and the second attribute information (for example, the object's sex of is female) extracted, by a proxy request destination device, from information on which the proxy request source device have performed the compression-encoding process; thus, it can be thought that the first attribute information and the second attribute information can be different. The present disclosure provides a processing device in which there is no such a discrepancy in extracted attribute information as described above, in other words, in which an appropriate parameter set to be used in a compression-encoding process is determined.

A processing device of the present disclosure includes: an encoder configured to compression-encode first uncompressed information, based on a first parameter set, and to generate first compression-encoded information, and configured to output the first compression-encoded information; a decoder configured to decode the first compression-encoded information to generate second uncompressed information, and configured to output the second uncompressed information; an image-and-sound processor configured to execute an attribute extraction process on the first uncompressed information to extract attribute information, and then to output first extracted attribute data which is the extracted attribute information, and configured to execute the attribute extraction process on the second uncompressed information to extract attribute information, and then to output second extracted attribute data which is the extracted attribute information; and a controller configured to determine, when the first extracted attribute data and the second extracted attribute data are identical, the first parameter set as an established parameter set.

Note that comprehensive or specific aspects of the configuration may be realized by a method, an integrated circuit, a computer program, or a computer readable recoding medium such as a CD-ROM, or may be realize by an arbitrary combination of the method, the integrated circuit, the computer program, and the recoding medium.

A processing device of the present disclosure can determine an appropriate parameter set to be used in a compression-encoding process.

### BRIEF DESCRIPTION OF DRAWINGS

FIG. 1 is an entire configuration diagram of a processing system according to an embodiment;

FIG. 2 is a configuration diagram of an image-and-sound processing device according to an embodiment;

FIG. 3 is a flowchart illustrating a flow in which encoded image data is transmitted to an external device according to an embodiment;

FIG. 4 is a flowchart illustrating a flow in which extracted attribute data is transmitted according to an embodiment;

FIG. 5 is a flowchart showing a flow of a proxy execution request and a proxy execution according to an embodiment;

FIG. 6A is a diagram illustrating image processing in an image-and-sound processing device according to an embodiment;

FIG. 6B is a diagram illustrating an image processing in an image-and-sound processing proxy execution server according to an embodiment;

FIG. 7 is a flowchart illustrating a flow of a process depending on a result of determination of execution or non-execution of a proxy execution according to an embodiment;

FIG. 8 is a flowchart illustrating a flow of a proxy process request to an image-and-sound processing proxy execution server according to an embodiment;

FIG. 9 is a flowchart illustrating a flow of determining an encode parameter set according to an embodiment;

FIG. 10 is a diagram illustrating an example of a correspondence table according to an embodiment;

FIG. 11 is a diagram illustrating an example of a list of candidate servers which proxy-executes an image-and-sound process according to an embodiment; and

FIG. 12 is a diagram illustrating an example of a list of candidate servers which proxy-execute an image-and-sound process according to an embodiment.

### DETAILED DESCRIPTION OF THE PREFERRED EMBODIMENT

<Knowledge on which the Present Disclosure is Based>

The present inventor has found that the following problems arose with respect to the system described in the section of “Description of the Related Art.”

Recently, surveillance cameras have been increasingly digitalized in a similar way to other devices for processing images. A digitalized surveillance camera generates encoded data whose data volume is reduced by encoding a picture captured by it and transmits the encoded data through an IP network.

On the other hand, a resolution of pictures captured by surveillance cameras is getting higher, such as from VGA (Picture Graphics Array) through HD (High Definition) and Full HD to Ultra HD; thus, even if the data volume is reduced by encoding, a load on a network bandwidth and a storage area of a server is becoming larger, whereby the data volume is required to be further reduced.

For this reason, there have been gradually commercialized surveillance cameras, each of which has a function that the surveillance camera does not transmit captured pictures or recorded sound from the surveillance camera to the server, but the surveillance camera performs image processing or sound processing in order to extract attribute information, and transmit only the extracted attribute data as extracted attribute information or transmits, when the extracted attribute data are meaningful information, the captured pictures or the recorded sound. The conventional common surveillance cameras have only function to transmit captured pictures and recorded sound; however, it can be thought that it will be common for a surveillance camera to have an image processing function and a sound processing function to extract attribute information to obtain extracted attribute data.

It can be thought that the image processing and the sound processing for extracting the attribute information to obtain the extracted attribute data are executed as application programs on the surveillance camera. Since the image processing and the sound processing for extracting the attribute information are often complex processes, and the image processing and the sound processing often need a large amount of hardware resources such as a CPU power, a memory capacity, and a dedicated circuit.

For this reason, it can be thought that when a plurality of application programs are to be concurrently executed to extract a plurality pieces of attribute information by using limited hardware resources of the surveillance camera, some of the application programs for extracting the attribute information cannot be executed due to short of the hardware resources of the surveillance camera, whereby the image processing and the sound processing for extracting the attribute information cannot be executed.

Unexamined Japanese Patent Publication No. 2008-123344 discloses a system in which an operation capability providing device executes a proxy process for a mobile terminal; however, the image processing executed by the operation capability providing device is for encoding a frame date by an in-frame coding; and the image processing is not supposed to perform a decoding process on the compressed image data, and is not supposed to perform the image processing or the sound processing for extracting the attribute information to obtain the extracted attribute data. When the image data are compression-encoded, information loss may occur; thus, it can happen depending on setting of a parameter set for the compression-encoding that there is a difference between the extracted attribute data (for example, the object's sex is female) which is the attribute information having been extracted, by the proxy request destination device, from the information on which the proxy request source device has performed the compression-encoding process and the extracted attribute data (for example, the object's sex is male) which is the attribute information having been extracted from the information on which the proxy request source device has not performed the compression-encoding process.

To solve these problems, a processing device of the present disclosure includes: an encoder configured to compression-encode first uncompressed information, based on a first parameter set, to generate first compression-encoded information, and configured to output the first compression-encoded information; a decoder configured to decode the first compression-encoded information to generate second uncompressed information, and configured to output the second uncompressed information; an image-and-sound processor configured to execute an attribute extraction process on the first uncompressed information to extract attribute information, and then to output first extracted attribute data which is the extracted attribute information, and configured to execute the attribute extraction process on the second uncompressed information to extract attribute information, and then to output second extracted attribute data which is the extracted attribute information; and a controller configured to determine, when the first extracted attribute data and the second extracted attribute data are identical, the first parameter set as an established parameter set.

With this arrangement, the processing device of the present disclosure can determine an appropriate parameter set to be used in compression-encoding. That is to say, two pieces of attribute information can be identical, one of which is the attribute information extracted, by the processing device, from the uncompressed picture-and-sound information which has not undergone the compression-encoding process, and the other of which is the attribute information which is extracted, by the image-and-sound processing proxy execution server, from the picture-and-sound information which has undergone the compression-encoding process. The picture-and-sound information may include at least one of picture information and sound information.

The established parameter set may be determined after the controller estimates that the execution of the attribute extraction process would use a greater amount of the hardware resources of the processing device than a permitted maximum usage amount of the hardware resources.

With this arrangement, the encoding parameter set can be determined at an appropriate time. In other words, it can be prevented that the encoding parameter set is determined even if the processing device does not request the image-and-sound processing proxy execution server to execute the proxy process of the image processing for extracting the attribute.

Configuration may be made such that wherein the image-and-sound processor holds a correspondence table which represents encode-parameter-set groups, each of a plurality of attribute extraction processes having a corresponding encode-parameter-set group that is one of the encode-parameter-set groups, the image-and-sound processor holds a correspondence table which represents encode-parameter-set groups, each of a plurality of attribute extraction processes having a corresponding encode-parameter-set group that is one of the encode-parameter-set groups, each of the encode-parameter-set groups includes a plurality of encode parameter sets, each of the plurality of encode parameter sets include one or more encode parameters, and the plurality of encode parameter sets include the first parameter set.

With this arrangement, the parameter set can be determined efficiently. That is to say, in the case where the correspondence table is held, the processing device can determine the parameter set to be temporarily set more rapidly than in the case where the correspondence table is not held.

Configuration may be made such that when the first extracted attribute data and the second extracted attribute data are not identical, the encoder compression-encodes the first uncompressed information to generate second compression-encoded information based on, instead of the first parameter set, a second parameter set which is one of a plurality of parameter sets included in the encode-parameter-set group corresponding to the attribute extraction process and which is a parameter set other than the first parameter set, and the encoder then outputs the second compression-encoded information, the decoder decodes the second compression-encoded information to generate third uncompressed information and outputs the third uncompressed information, the image-and-sound processor outputs third extracted attribute data which is attribute information extracted from the third uncompressed information, and the controller determines, when the first extracted attribute data and the third extracted attribute data are identical, the second parameter set as an established parameter set.

With this arrangement, the parameter set can be determined efficiently.

Configuration may be made such that the processing device includes a proxy-execution-server determination unit, the proxy-execution-server determination unit holds a candidate list including a candidate server for an image-and-sound processing proxy server which executes, substituting for the processing device, the attribute extraction process on third compression-encoded information which has been generated by compression-encoding fourth uncompressed information, based on the established parameter set, the proxy-execution-server determination unit asks the candidate server included in the candidate list whether the attribute extraction process is possible, and the processing device obtains the fourth uncompressed information after obtaining the first uncompressed information.

With this arrangement, the image-and-sound processing proxy execution server for the processing device can be determined efficiently. In other words, in order to determine the image-and-sound processing proxy execution server, the processing device has only to inquire a candidate server included in the candidate list.

Configuration may be made such that an external device which is a device other than the processing device holds a candidate list including a candidate server for an image-and-sound processing proxy server which executes, substituting for the processing device, the attribute extraction process on third compression-encoded information which has been generated by compression-encoding fourth uncompressed information, based on the established parameter set, the external device asks the candidate server included in the candidate list whether the attribute extraction process is possible, and the processing device obtains the fourth uncompressed information after obtaining the first uncompressed information.

With this arrangement, a configuration of the processing device can be simplified. In other words, the processing device does not need to hold the candidate list to determine the image-and-sound processing proxy execution server.

Configuration may be made such that the candidate list includes pieces of candidate server information each of the pieces of candidate server information corresponding to each of the plurality of attribute extraction processes, and a candidate server identified by using the candidate server information is a candidate server for the image-and-sound processing proxy server which executes the corresponding attribute extraction process, substituting for the processing device.

With this arrangement, the processing device can efficiently determine the image-and-sound processing proxy server.

The attribute extraction process may be a face identification process, the attribute information may include at least one of a sex and an age category, and the first parameter set may include an image resolution.

Note that the embodiment to be described below represents a comprehensive or specific example. Values, forms, components, positions of the components, steps, orders of the steps, and the like to be described in the following embodiment are an example and are not supposed to limit the present disclosure. Further, of the components of the following embodiment, the components which are not described in the independent claim representing the most significant concept of the invention will be described as arbitrary components.

The embodiment will be described below with reference to the drawings.

### EXEMPLARY EMBODIMENT

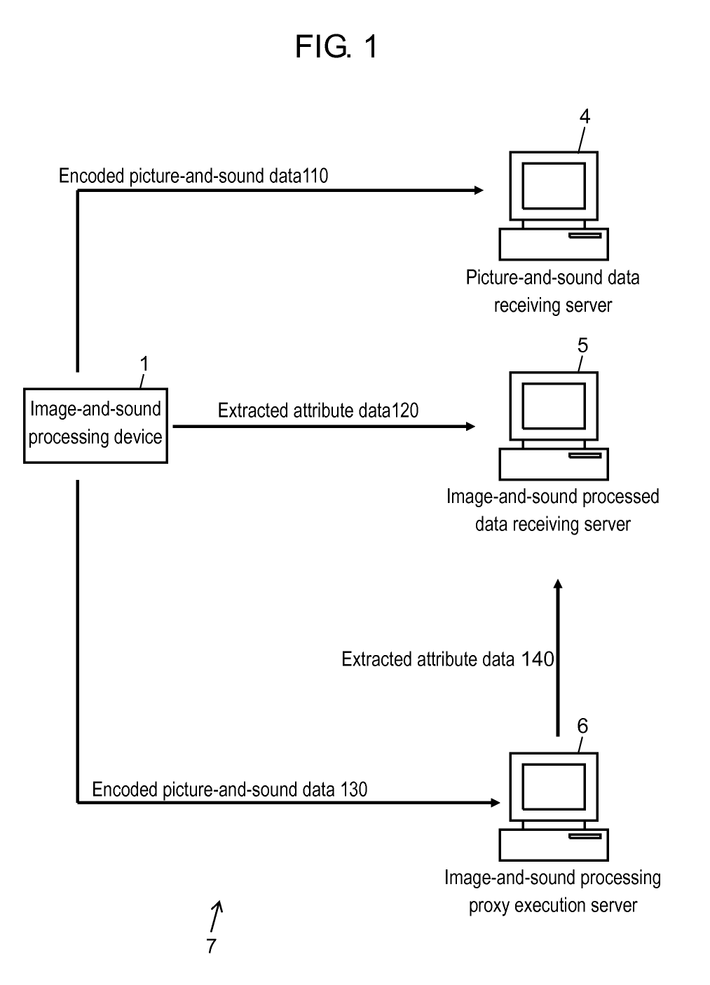

FIG. 1 illustrates an entire configuration diagram of processing system 7 of the embodiment. Processing system 7 includes image-and-sound processing device 1, picture-and-sound data receiving server 4, image-and-sound processed data receiving server 5, and image-and-sound processing proxy execution server 6.

Image-and-sound processing device 1 obtains data such as image data and sound data from an input device such as a camera and a microphone, and then outputs those data to an external device after performing some processes on these data. The external device includes picture-and-sound data receiving server 4, image-and-sound processed data receiving server 5, and image-and-sound processing proxy execution server 6. Image-and-sound processing device 1 and the external device may communicate with each other through an IP network. Image-and-sound processing device 1 obtains data such as image data and sound data from a camera, a microphone, and the like, encodes the data, and then outputs encoded picture-and-sound data 110 to picture-and-sound data receiving server 4. Image-and-sound processing device 1 may encode at least one of the image data and the sound data. Encoded picture-and-sound data 110 may include at least one of the encoded picture date and the encoded sound data.

Image-and-sound processing device 1 obtains data such as image data and sound data from a camera or a microphone, executes image-and-sound processing to extract attribute information from these data and to generate extracted attribute data 120 as the extracted attribute information, and outputs extracted attribute data 120 to image-and-sound processed data receiving server 5. Note that extracted attribute data 120 may include at least one of the extracted attribute data generated based on the image data and the extracted attribute data generated based on the sound data. Further, the extracted attribute data generated based on the image data and the extracted attribute data generated based on the sound data may be added to determine one piece of data, and this piece of data may be determined as extracted attribute data 120.

Image-and-sound processing device 1 obtains data such as image data and sound data from a camera or a microphone, encodes the data, and outputs encoded picture-and-sound data 130 as encoded data to image-and-sound processing proxy execution server 6. Note that encoded picture-and-sound data 130 may include at least one of the encoded picture date and the encoded sound data.

Picture-and-sound data receiving server 4 receives encoded picture-and-sound data 110 transmitted by image-and-sound processing device 1. Picture-and-sound data receiving server 4 can decode received encoded picture-and-sound data 110 to display the decoded picture-and-sound data on a display. Picture-and-sound data receiving server 4 may decode at least one of the encoded image data and the encoded sound data. Further, picture-and-sound data receiving server 4 can write received encoded picture-and-sound data 110 in a recording device built in picture-and-sound data receiving server 4 or a recording device connected thereto, as they are.

Image-and-sound processed data receiving server 5 receives extracted attribute data 120 transmitted by image-and-sound processing device 1 and extracted attribute data 140 transmitted by image-and-sound processing proxy execution server 6. Image-and-sound processed data receiving server 5 can display received extracted attribute data 120 and received extracted attribute data 140 on a display. Further image-and-sound processed data receiving server 5 can write received extracted attribute data 120 and received extracted attribute data 140 in a storage device built in image-and-sound processed data receiving server 5 or a recording device connected thereto. Image-and-sound processed data receiving server 5 can analyze a plurality of extracted attribute data accumulated in the recording device and display a result of the analysis on a display.

Image-and-sound processing proxy execution server 6 receives encoded picture-and-sound data 130 transmitted by image-and-sound processing device 1, executes, as a substitute of image-and-sound processing device 1, the image-and-sound processing for extracting the attribute information to generate extracted attribute data 140 as the extracted attribute information and outputs extracted attribute data 140 to image-and-sound processed data receiving server 5. Image-and-sound processing proxy execution server 6 may execute at least one of the generation of the extracted attribute data based on the encoded picture date and the generation of the extracted attribute data based on the encoded sound data. Extracted attribute data 140 may include at least one of the extracted attribute data generated based on the image data and the extracted attribute data generated based on the sound data. Further, the extracted attribute data generated based on the image data and the extracted attribute data generated based on the sound data may be added to determine one piece of data, and this piece of data may be determined as extracted attribute data 140.

Note that, in FIG. 1, picture-and-sound data receiving server 4, image-and-sound processed data receiving server 5, and image-and-sound processing proxy execution server 6 are described as individual servers; however, the functions performed in these servers may be performed on one server or may be shared and performed on a plurality of servers.

In the case where processing system 7 includes a plurality of image-and-sound processing devices, an image-and-sound processing device other than image-and-sound processing device 1 may hold and execute the functions of picture-and-sound data receiving server 4, image-and-sound processed data receiving server 5, and image-and-sound processing proxy execution server 6.

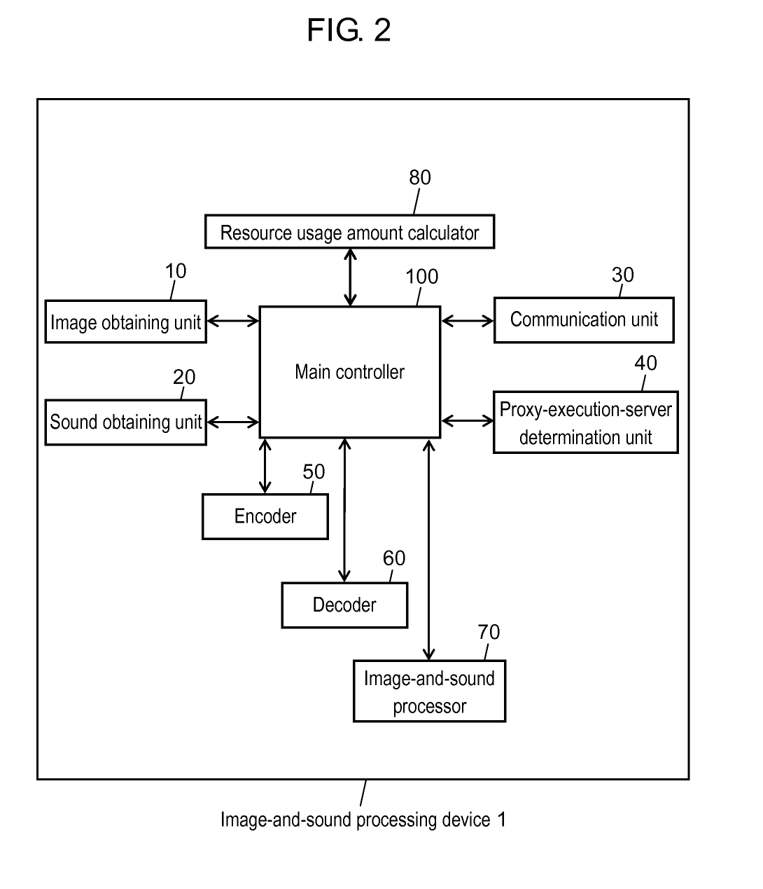

FIG. 2 is a configuration diagram of image-and-sound processing device 1. Image-and-sound processing device 1 includes image obtaining unit 10, sound obtaining unit 20, communication unit 30, proxy-execution-server determination unit 40, encoder 50, decoder 60, image-and-sound processor 70, resource usage amount calculator 80, and main controller 100.

Image obtaining unit 10 is equipped with a camera and obtains image data captured by the camera. Image obtaining unit 10 is equipped with a picture input terminal such as an analog picture terminal and an HDMI (registered trademark) (High Definition Multimedia Interface) terminal to receive pictures transmitted from another device and to obtain image data. Image obtaining unit 10 is equipped with a network terminal for, for example, the Ethernet, receives picture date transmitted through a network, and in some cases decodes the picture date to obtain image data. Note that, the obtained image data are outputted as uncompressed image data in, for example, an RGB format (format representing intensities of red, green, and blue), a YCbCr format (format for representing colors by values calculated by a conversion formula based on the value represented in the RGB format; hereinafter, YCbCr is written as YC), or RAW (signals obtained from an imaging element, as they are).

Sound obtaining unit 20 is equipped with a microphone to obtain sound data inputted in the microphone. Alternatively, sound obtaining unit 20 is equipped with a sound input terminal such as an analog sound terminal and an HDMI (registered trademark) (High-Definition Multimedia Interface) terminal, and receives sound transmitted from another device to obtain sound data. Sound obtaining unit 20 is equipped with a network terminal for, for example, the Ethernet, receives sound data sent from another device, and in some cases decodes the sound data that is decoded data, to obtain decoded sound data. Note that the obtained sound data are outputted as uncompressed sound data in, for example, a bitstream format.

Communication unit 30 is means for transmitting and receiving data to and from an external device through a network terminal such as Ethernet, Bluetooth (registered trademark) and NFC (Near Field Communication).

Proxy-execution-server determination unit 40 determines image-and-sound processing proxy execution server 6 as an external device which executes, as a substitute of image-and-sound processing device 1, the image-and-sound processing for extracting the attribute information to obtain the extracted attribute data. When proxy-execution-server determination unit 40 determines image-and-sound processing proxy execution server 6, proxy-execution-server determination unit 40 may hold an image-and-sound processing proxy execution candidate server list representing candidate servers for proxy executing the image-and-sound process, and may determine image-and-sound processing proxy execution server 6 from the candidate servers included in the image-and-sound processing proxy execution candidate server list.

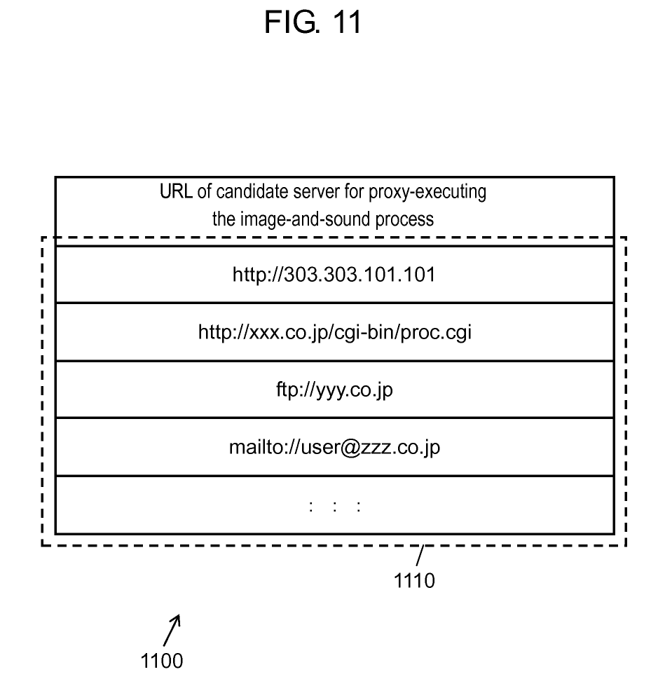

FIG. 11 illustrates an example of a configuration of the image-and-sound processing proxy execution candidate server list. Image-and-sound processing proxy execution candidate server list 1100 includes URL group 1110 of candidate servers which proxy-execute the image-and-sound process.

Further, a search server outside of image-and-sound processing device 1 may be requested to search a server which proxy-executes the image-and-sound process, and image-and-sound processing proxy execution server 6 may be determined by using an obtained search result (URL information of a candidate server). That is to say, the external search server may hold a list similar to image-and-sound processing proxy execution candidate server list 1100, receive from image-and-sound processing device 1 a content of the proxy process, for example, information on what kind of proxy process of an image processing (extraction of attribute), inquire the candidate servers on the list whether that kind of proxy process possible, and send to image-and-sound processing device 1 the URL information of the candidate server which has replayed positively.

Encoder 50 encodes uncompressed image data in a RAW format such as an RGB format and a YC format by an arbitrary image compression format such as MPEG1/2/4, H.264, JPEG, and JPEG2000. Encoder 50 encodes uncompressed sound data in, for example the bitstream by an arbitrary sound compression format such as MP3, AC3, and AAC.

Decoder 60 decodes image data encoded in an arbitrary image compression format such as MPEG1, MPEG2, MPEG4, H.264, JPEG, and JPEG2000 into uncompressed image data in a RAW format, an RGB format, or a YC format. Decoder 60 decodes sound data encoded in an arbitrary sound compression format such as MP3, AC3, and AAC into uncompressed sound data in, for example, the bitstream.

Image-and-sound processor 70 executes image processing on the image data obtained by image obtaining unit 10, the image data decoded by decoder 60, and the image data encoded by encoder 50 to extract the attribute information to obtain the extracted attribute data. Image-and-sound processor 70 performs a sound analysis on the sound data obtained by sound obtaining unit 20, the sound data decoded by decoder 60, and the sound data encoded by encoder 50 to extract the attribute information to obtain the extracted attribute data.

The term “image processing” in the present specification and drawings refers to image processing for extracting attribute information to obtain extracted attribute data, and the term “sound processing” refers to sound processing for extracting attribute information to obtain extracted attribute data. Extracted attribute data will be described later.

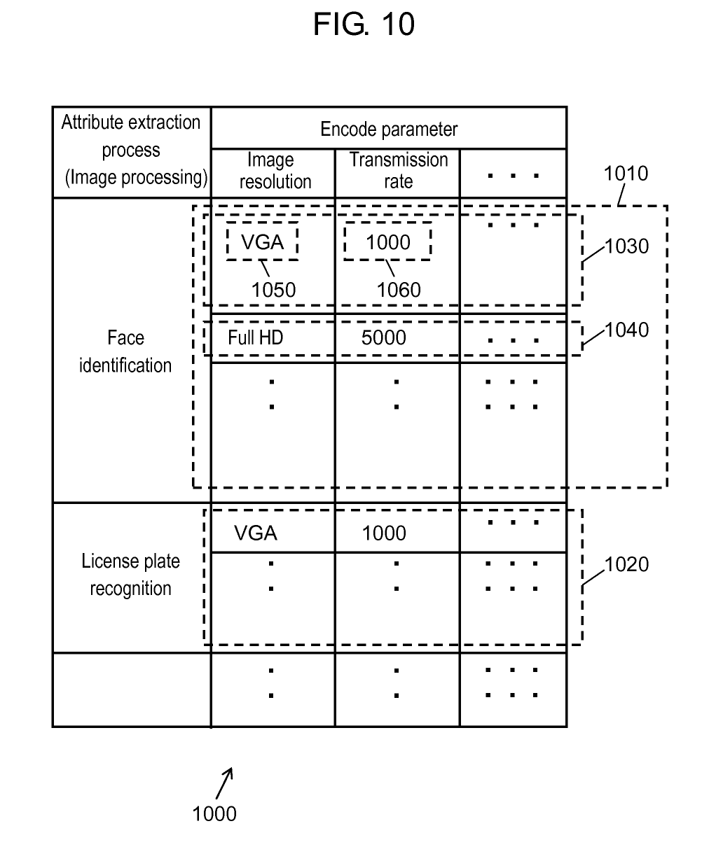

Image-and-sound processor 70 includes correspondence table 1000 as illustrated in FIG. 10, for example. Correspondence table 1000 includes encode-parameter-set groups. Each of the encode-parameter-set groups corresponds to each of the attribute extraction processes. For example, encode-parameter-set group 1010 corresponds to the attribute extraction process (image processing) for the face identification, and encode-parameter-set group 1020 corresponds to the attribute extraction process (image processing) for the license plate identification. Each of the encode-parameter-set groups includes a plurality of encode parameter sets. For example, encode-parameter-set group 1010 includes encode parameter set 1030 and encode parameter set 1040.

Each of the encode parameter sets includes one or more encode parameters. For example, encode parameter set 1030 includes encode parameter 1050 and encode parameter 1060. Encode parameter 1050 is information for specifying an image resolution, and encode parameter 1060 is information for specifying a transmission rate. Encode parameter set 1030 may include only one encode parameter. For example, encode parameter set 1030 may include only encode parameter 1050 for specifying an image resolution.

Resource usage amount calculator 80 is means for calculating a usage amount or a usage amount per unit time of various devices (hardware resources) such as a CPU, a RAM, a recoding medium, and a network of image-and-sound processing device 1. Resource usage amount calculator 80 may calculate usage rate per unit time of those various devices (hardware resources).

Main controller 100 controls image obtaining unit 10, sound obtaining unit 20, communication unit 30, proxy-execution-server determination unit 40, encoder 50, decoder 60, image-and-sound processor 70, and resource usage amount calculator 80 to realizes a series of processes. For example, main controller 100 performs control to encode, by encoder 50, the image data obtained by image obtaining unit 10 and sound data obtained by sound obtaining unit 20, and performs control to transmit the decoded data to picture-and-sound data receiving server 4 by communication unit 30.

Main controller 100 performs control to execute, by image-and-sound processor 70, the image processing on the image data obtained by image obtaining unit 10 and the sound processing on the sound data obtained by sound obtaining unit 20, and performs control to transmit extracted attribute data 120 as the result of the processing from communication unit 30 to image-and-sound processed data receiving server 5.

Main controller 100 requests, if the execution of, for example, the image processing and the sound processing would make the usage amount of the hardware resources excess the permitted value, image-and-sound processing proxy execution server 6 determined on proxy-execution-server determination unit 40 to perform proxy execution.

Further in this case, main controller 100 performs control: to determine an encode parameter set so that the extracted attribute data as the result of executing the image processing and the sound processing on image-and-sound processing proxy execution server 6 and the extracted attribute data as the result of executing the image processing and the sound processing on image-and-sound processing device 1 are identical; to encode by encoder 50 the image data obtained by image obtaining unit 10 and the sound data obtained by sound obtaining unit 20 by using the determined encode parameter set; and then to send encoded picture-and-sound data 130 from communication unit 30 to image-and-sound processing proxy execution server 6.

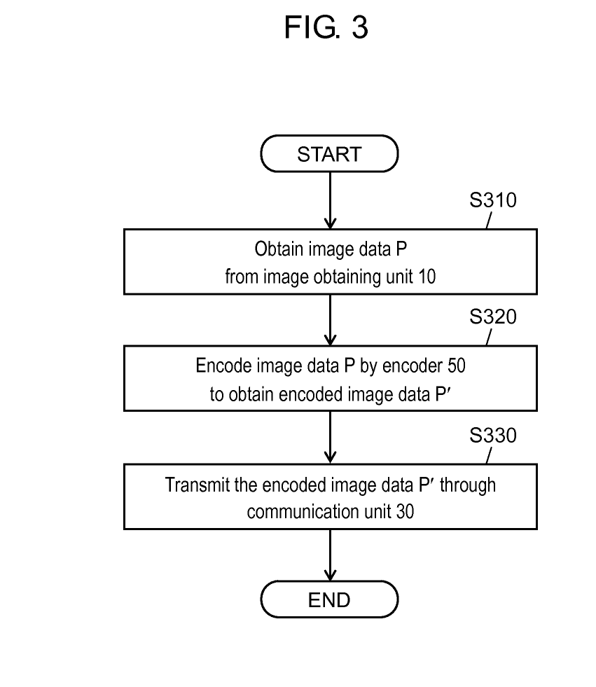

FIG. 3 is a flowchart illustrating a flow of the encoded image data being transmitted to the external device such as picture-and-sound data receiving server 4 and image-and-sound processing proxy execution server 6.

First, main controller 100 instructs image obtaining unit 10 to obtain image data P. Image obtaining unit 10 having received the instruction obtains image data P from the camera built in image obtaining unit 10 or an image input device such as an external picture input terminal (step S310).

Subsequently, main controller 100 instructs encoder 50 to encode the image data P obtained in step S310. Encoder 50 having received the instruction encodes the image data P in an arbitrary image compression format such as H.264 to obtain encoded image data P′ (step S320).

Finally, main controller 100 instructs communication unit 30 to transmit the encoded image data P′ obtained in step S320 to the external device such as picture-and-sound data receiving server 4 and image-and-sound processing proxy execution server 6. Communication unit 30 having received the instruction transmits the encoded image data P′ to the external device such as picture-and-sound data receiving server 4 and image-and-sound processing proxy execution server 6 by using a protocol, for example, HTTP (Hyper Text Transfer Protocol) or RTP (Realtime Transfer Protocol) which can be received by the external device such as picture-and-sound data receiving server 4 and image-and-sound processing proxy execution server 6 (step S330).

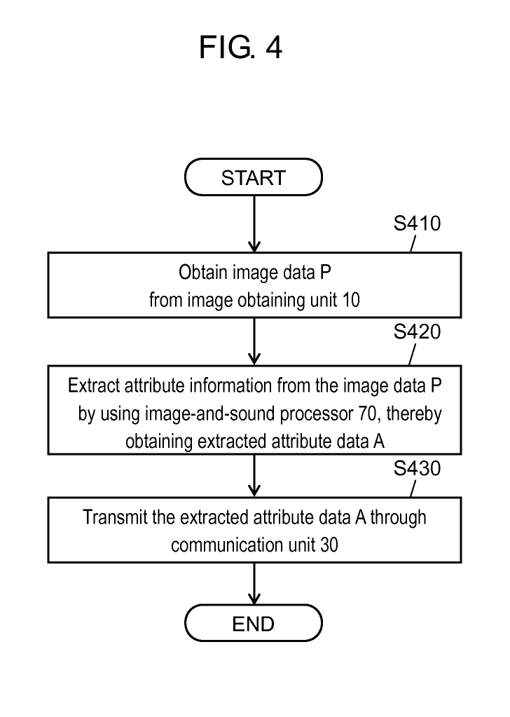

FIG. 4 is a flowchart illustrating a flow in which the image data are subjected to image processing, and the extracted attribute data as the result data of the processing are transmitted to image-and-sound processed data receiving server 5 as the external device.

First, image-and-sound processing device 1 is instructed to obtain, for example, image data from the external device through communication unit 30 and to extract specific attribute information from the image data. If image-and-sound processing device 1 does not have a function to extract the attribute information, image-and-sound processor 70 may be configured to obtain from the outside an application program equipped with the function and hold the obtained application program (not shown in the drawings).

Next, main controller 100 instructs image obtaining unit 10 to obtain image data P. Image obtaining unit 10 having received the instruction obtains image data P from the camera built in image obtaining unit 10 or the image input device such as the external picture input terminal (step S410).

Subsequently, main controller 100 instructs image-and-sound processor 70 to execute image processing for extracting specific attribute information from image data P obtained in step S410. Image-and-sound processor 70 having received the instruction operates the application program specified by the external device of a plurality of application programs held therein so as to perform extraction of the attribute information specified by the external device with respect to image data P to obtain extracted attribute data A (step S420).

The image processing is, for example, a face identification process and a license plate identification process. In the case where the image processing is the face identification process, the extracted attribute data are, for example, face component information (positional information of components of a face such as eyes, a nose, and a mouth and contour information of a whole face) of a person identified in the image. Alternatively, the extracted attribute data may be an age category (an infant, a child, or an adult) or a sex category (a male or a female) of a person identified in the image.

One image processing (one image processing application program) may be used to extract one piece of attribute information and generate one piece of extracted attribute data, or may be used to extract a plurality of pieces of attribute information and generate a plurality of pieces of extracted attribute data. For example, one face identification process (one image processing application program) may be used to extract only the age category of a person having the largest face region in the image, or may be used to extract both the age category and the sex category of a person having the largest face region in the image.

In the case where the image processing is the license plate identification process, numbers and characters (for example, “5NR43”) shown on a license plate of an automobile identified in the image may be the extracted attribute data, for example.

The sound processing for extracting the attribute information and obtain the extracted attribute data may be, for example, a word recognition process, and the extracted attribute data may be one word (for example, “Hello”).

Finally, main controller 100 instructs communication unit 30 to transmit the extracted attribute data A as an image processing result obtained in step S420 to image-and-sound processed data receiving server 5 as the external device. Communication unit 30 having received the instruction transmits the extracted attribute data A as the image processing result to image-and-sound processed data receiving server 5 as the external device by using a protocol, for example, HTTP (Hyper Text Transfer Protocol), FTP (File Transfer Protocol), and SMTP (Simple Mail Transfer Protocol) which can be received by image-and-sound processed data receiving server 5 as the external device (step S430).

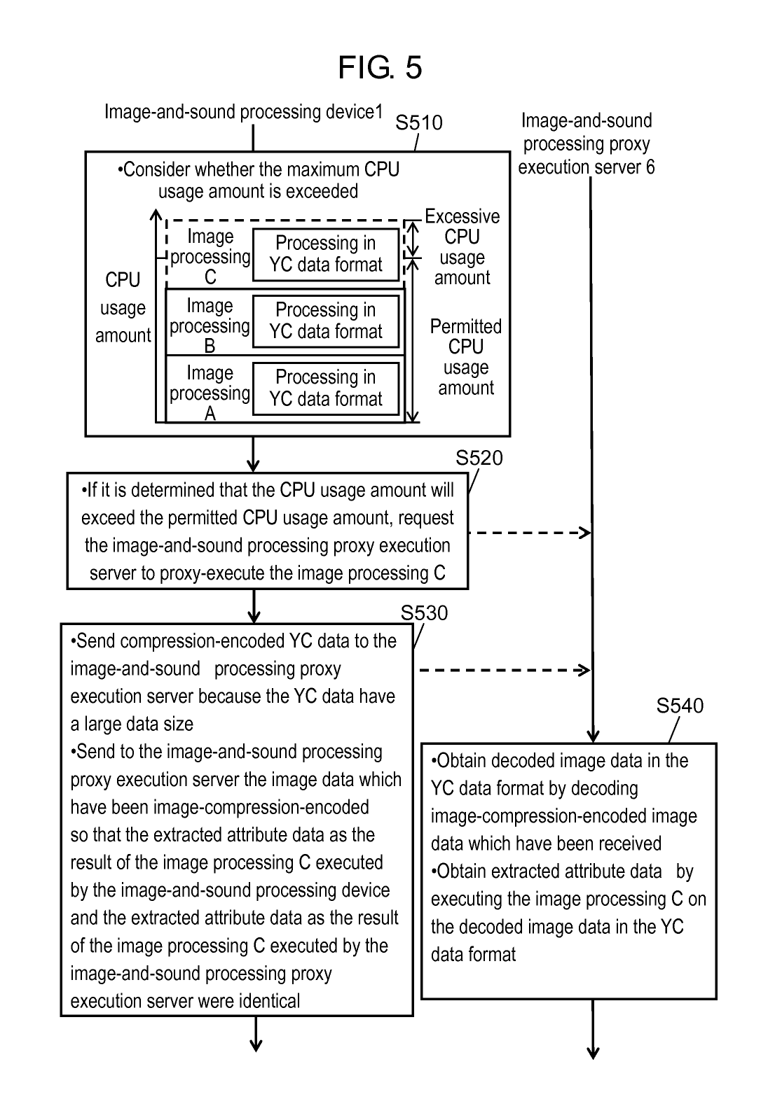

FIG. 5 is a flowchart illustrating a flow of a proxy execution request and the proxy execution in the embodiment.

First, image-and-sound processing device 1 has started to operate an image processing A and an image processing B, and the total CPU usage amount for the two image processings is lower than a maximum CPU usage amount; thus, the image processing A and the image processing B are being executed at a state of no delay. Because an image processing is executed in most cases by using an uncompressed data format such as YC format and an RGB format, it is assumed here that the image processing A and the image processing B are both subjected to the image processing in the YC format.

Next, image-and-sound processing device 1 is about to start newly to execute an image processing C. At this time, main controller 100 of image-and-sound processing device 1 checks whether the total of the current CPU usage amount per unit time and the estimated CPU usage amount of the image processing C per unit time does not exceed the maximum CPU usage amount per unit time (step S510). If the total does not exceed, image-and-sound processor 70 starts the image processing C. On the other hand, if the total exceeds, it is determined that there is a high possibility that image-and-sound processor 70 would not operate as well as expected even if image-and-sound processor 70 started to execute the image processing C, and main controller 100 of image-and-sound processing device 1 determines to make the external device proxy-execute the image processing C.

Subsequently, image-and-sound processing device 1 looks for an external device which can proxy-execute the image processing C. Here, it is assumed that image-and-sound processing proxy execution server 6 is selected as the external device. Then, image-and-sound processing device 1 requests image-and-sound processing proxy execution server 6 to execute the image processing C (step S520). Configuration may be made such that when image-and-sound processing device 1 determines the external device which proxy-executes the image processing C, image-and-sound processing device 1 may hold, for example, image-and-sound processing proxy execution candidate server list 1100 as shown in FIG. 11, and image-and-sound processing device 1 may inquire each candidate server sequentially from the top of the list whether the proxy execution of the image processing C is possible, and may determine the candidate server which replies that the proxy execution is possible, as the image-and-sound processing proxy execution server 6. For example, of the URLs of the candidate servers included in image-and-sound processing proxy execution candidate server list 1100, image-and-sound processing device 1 first inquires the candidate server whose URL is (http://303.303.101.101) whether the proxy process is possible, and if the proxy execution is not possible in this candidate server, image-and-sound processing device 1 next inquires the candidate server whose URL is (http://xxx.co.jp/cgi-bin/proc.cgi) whether the proxy process is possible.

Further, image-and-sound processing device 1 may inquire a server (hereinafter, referred to as an external-process notification server) which informs which external device can execute the proxy execution of the image processing C, and may determine the external device informed by the external-process notification server as image-and-sound processing proxy execution server 6.

The external-process notification server may previously store a list of candidate servers which can execute proxy processes, and may obtain information for identifying the image processing C from image-and-sound processing device 1, may inquire sequentially each candidate server from the top of the list whether the image processing C can be proxy-executed, and may inform image-and-sound processing device 1 of a URL of the candidate server which has replied that the proxy execution was possible.

Image-and-sound processing proxy execution server 6 which has been requested to proxy-execute the image processing C gets ready for executing the image processing C.

Subsequently, image-and-sound processing device 1 transmits data necessary for image-and-sound processing proxy execution server 6 to execute the image processing C to image-and-sound processing proxy execution server 6. Because image processing is usually executed by using image data in a YC data format, data in the YC data format is preferably transmitted to image-and-sound processing proxy execution server 6. However, the image data in the YC data format have a large data volume, and are thus not appropriate to be transmitted through a network. For this reason, image-and-sound processing device 1 does not send the image data in the YC data format to image-and-sound processing proxy execution server 6 as they are, but image-compression-encode the image data in the YC data format to transmit image-compression-encoded image data to image-and-sound processing proxy execution server 6 (step S530).

Image-and-sound processing proxy execution server 6 receives the image-compression-encoded image data and decodes the image-compression-encoded image data to get decoded image data in the YC data format, and then executes the image processing C on the decoded image data to obtain the extracted attribute data (step S540).

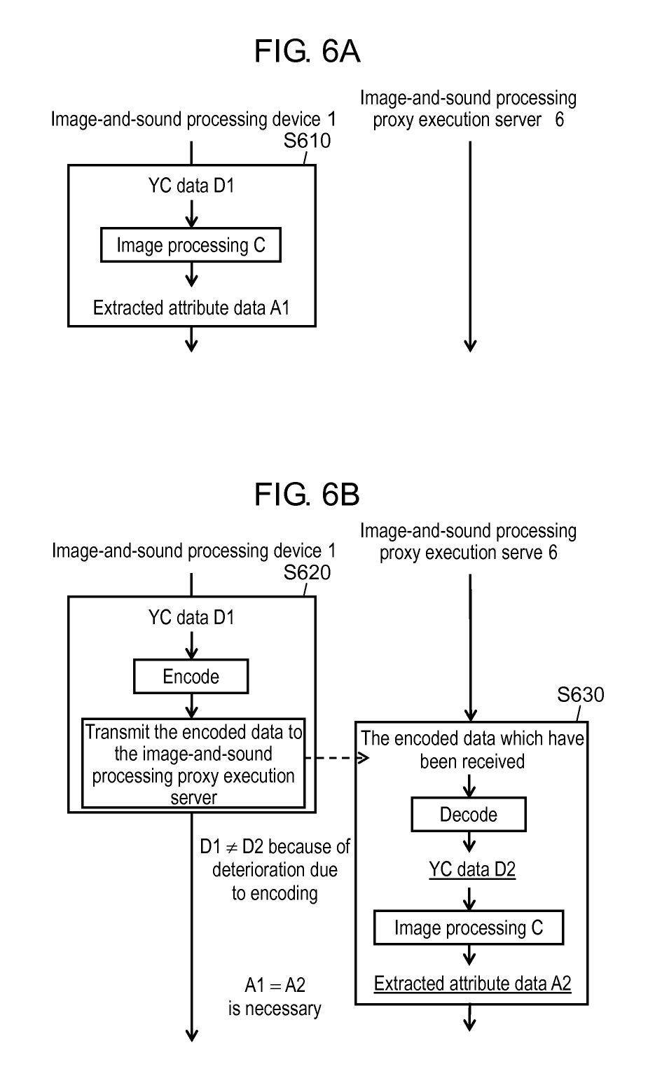

At this time, depending on the parameter set used for the image-compression-encoding, the extracted attribute data as the result of executing the image processing C on image-and-sound processing device 1 and the extracted attribute data as the result of executing the image processing C on image-and-sound processing proxy execution server 6 can be different. FIG. 6A and FIG. 6B are diagrams illustrating this issue.

FIG. 6A is a diagram illustrating the image processing C on image-and-sound processing device 1. The image processing C is executed on image-and-sound processing device 1, but not executed on image-and-sound processing proxy execution server 6.

Image-and-sound processing device 1 executes the image processing C on YC data D1 that is uncompressed data outputted from image obtaining unit 10 to obtain extracted attribute data A1 as image processing result data (step S610).

FIG. 6B is a diagram illustrating the image processing C in image-and-sound processing proxy execution server 6. The diagram illustrates that the image processing C is not executed on image-and-sound processing device 1 but is proxy-executed on image-and-sound processing proxy execution server 6. Image-and-sound processing device 1 image-compression-encodes (encodes) the YC data D1 that is uncompressed data outputted from image obtaining unit 10 and transmits the encoded data to image-and-sound processing proxy execution server 6 (step S620).

Image-and-sound processing proxy execution server 6 decodes the received image-compression-encoded (encoded) data to obtain YC data D2 that is uncompressed data. The image processing C is executed on the YC data D2 that is the decoded image data to obtain extracted attribute data A2 as image processing result data (step S630).

Here, the YC data D2 is the data generated by image-compression-encoding (encoding) the YC data D1 and then decoding the encoded data. Since, there is a data loss due to the image-compression-encoding, the YC data D1 are not the same as the YC data D2. For this reason, the image processing result data A1 that is the result of executing the image processing C on the YC data D1 and the image processing result data A2 that is the result of executing the YC data D2 can be different. However, it is possible to cause A1 and A2 to be identical by adjusting the parameter set such as a resolution, a compression rate, and a compression method used for the image-compression-encoding. For this purpose, image-and-sound processing device 1 needs to execute the image-compression-encoding process on the YC data D1 in step S620 by using such an image compression parameter set that the extracted attribute data A1 that is an image processing result and the extracted attribute data A2 that is an image processing result are identical.

As described above, image-and-sound processing proxy execution server 6 receives the image-compression-encoded image data transmitted by image-and-sound processing device 1. Then, image-and-sound processing proxy execution server 6 decodes the image-compression-encoded image data to obtain the decoded image data in the YC data format, and executes the image processing C (step S540). Image-and-sound processing proxy execution server 6 holds the extracted attribute data as the result of executing the image processing C by itself or transmits the extracted attribute data to image-and-sound processed data receiving server 5.

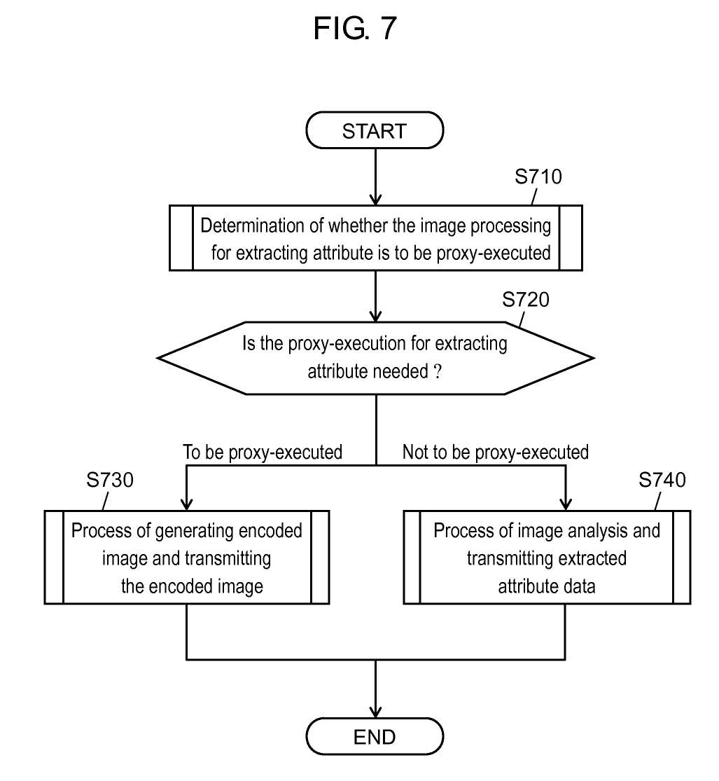

FIG. 7 is a flowchart illustrating a process flow depending on the determination of execution or non-execution of the proxy execution.

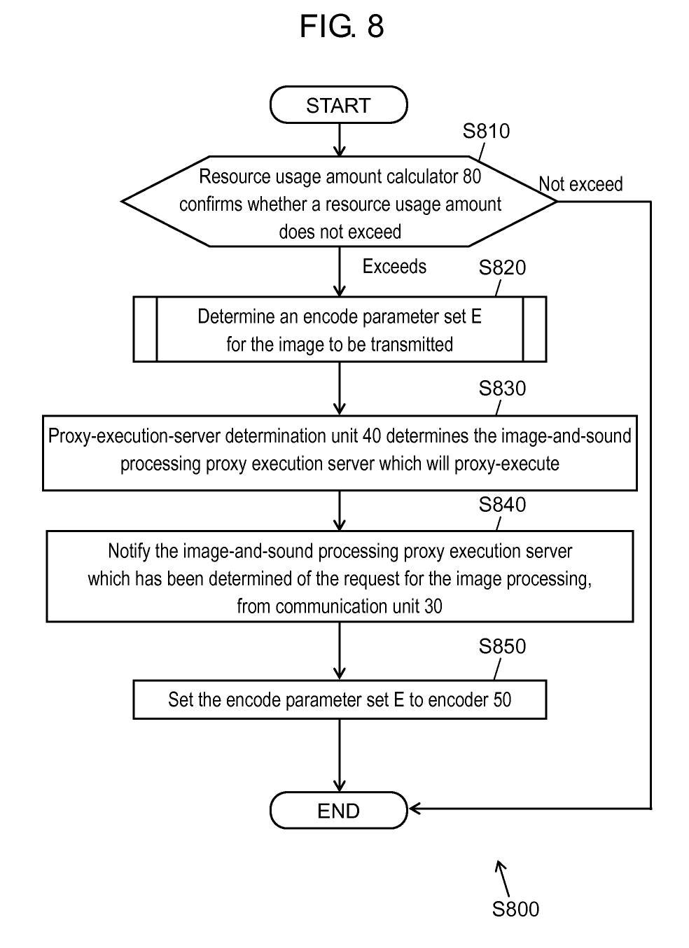

First, main controller 100 determines whether image-and-sound processing device 1 executes the image processing or the external device proxy-executes the image processing (step S710). Here, the external device is assumed to be image-and-sound processing proxy execution server 6. The process in step S800 illustrated in FIG. 8 may be executed in step S710.

Next, based on the result of the determination in step S710, main controller 100 branches the processing (step S720).

If image-and-sound processing proxy execution server 6 determines to proxy-execute the image processing, image-and-sound processing device 1 executes processing for generating encoded image and transmitting the encoded image to image-and-sound processing proxy execution server 6 (step S730). The detailed sequence of step S730 is represented by the sequence of steps S310 to S330 illustrated in FIG. 3.

If image-and-sound processing device 1 determines to execute the image processing, image-and-sound processing device 1 executes the image processing and transmits the extracted attribute data as the image processing result to image-and-sound processed data receiving server 5 (step S740). The detailed sequence of step S740 is represented by the sequence of steps S410 to S430 illustrated in FIG. 4.

In the case where the image data are obtained every 10 minutes, and the attribute of the image data is extracted, the processes in steps S710 and S720 may be executed only at the previously determined time (for example, once a day at seven o'clock), and the determination result of execution or non-execution of the proxy execution may be held. Then, at the time (from 07:10 to 06:50 the next day) other than that, the processes in steps S710 and S720 are not executed, and step S730 or step S740 may be executed depending on the held determination result.

FIG. 8 is a flowchart illustrating a flow of a proxy process request to image-and-sound processing proxy execution server 6.

First, main controller 100 obtains the usage amount of the resources (hardware resources) from resource usage amount calculator 80 and checks whether the total of the obtained usage amount of the resources (hardware resources) and the usage amount of the resources (hardware resources) for the image processing to be operated from now does not exceed the permitted value of the usage amount of the resources (hardware resources) (step S810). If the total does not exceed, it is determined that the proxy process request will not be issued, and this flowchart is finished. On the other hand, if the total exceeds, it is determined that the proxy process request will be issued, and the process goes to the next step. Here, the resource usage amount (usage of the hardware resources) includes a CPU usage amount, a RAM usage amount, a storage-area usage amount. If the resource usage amount is assumed to be the CPU usage amount, the same check as the content illustrated in step S510 may be executed.

Next, main controller 100 determines an encode parameter set E to be used to encode the image data to be transmitted (step S820). The encode parameter set includes one or more encode parameters. The encode parameter may be, for example, an image resolution, a transmission rate, a compression rate, or a compression method. The encode parameter is set on the encoder with reference to correspondence table 1000 before encoding is executed. Correspondence table 1000 has a plurality of encode parameter sets for each of the image processings such as face identification and license plate identification (each of the face identification application program and the license plate identification application). FIG. 10 illustrates an example that one encode parameter set includes a plurality of encode parameters. Encode parameter set 1030 includes, for example, a plurality of encode parameters 1050 and 1060. Note that each encode parameter set may include only one encode parameter.

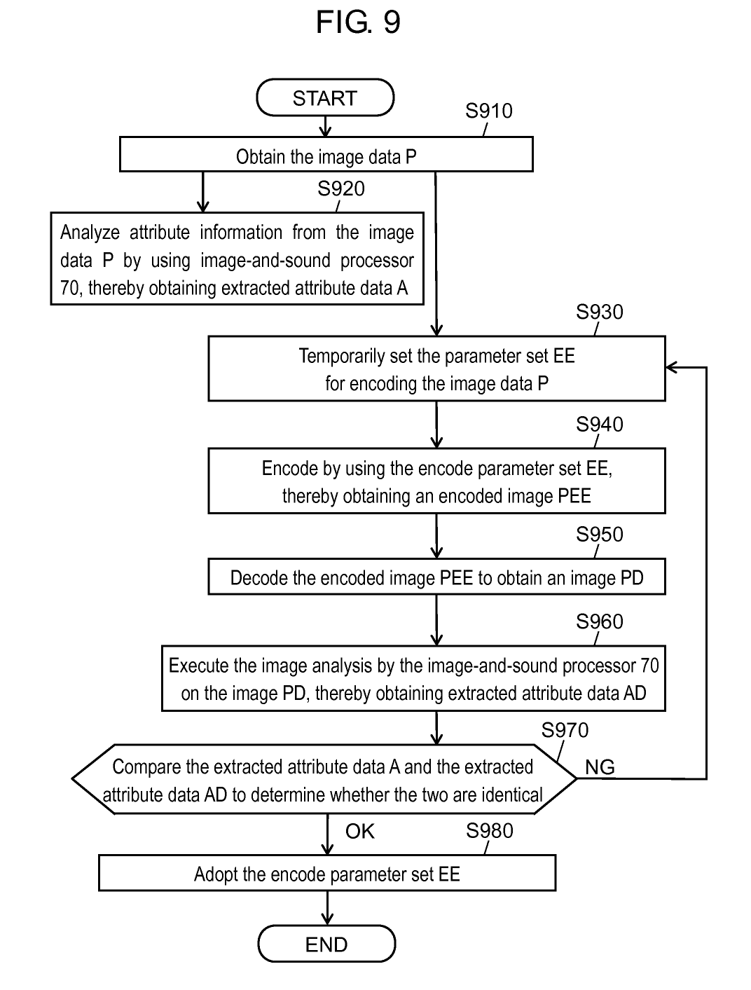

Here, the encode parameter set E is determined so that the extracted attribute data that is the image processing result of the image processing executed on image-and-sound processing device 1 and the extracted attribute data that is the result of the image processing executed, by image-and-sound processing proxy execution server 6, by using the encoded image which image-and-sound processing proxy execution server 6 has received from image-and-sound processing device 1 are identical. A detailed sequence in step S820 will be described with reference to FIG. 9.

The image analysis executed in step S820 corresponds to, for example, the image processing C illustrated in step S510; however, when the encode parameter set is determined in step S820, it is necessary for the image processing C to be executed on image-and-sound processing device 1. Thus, to execute the image processing C, the processing of the image processing B may be suspended. Further, if the image processing B is repeated on a regular basis, the image processing C may be executed during the time after the end of the current image processing B and before the start of the next image processing B.

Next, main controller 100 instructs proxy-execution-server determination unit 40 to determine image-and-sound processing proxy execution server 6 which will proxy-execute the image processing (step S830). When image-and-sound processing device 1 determines the external device which will proxy-execute the image processing C, image-and-sound processing device 1 may hold a candidate list (for example, image-and-sound processing proxy execution candidate server list 1100) of external devices on which the proxy execution of the image processing C is possible, and image-and-sound processing device 1 may inquire each external device sequentially from the top of the candidate list whether the proxy execution of the image processing C is possible, and may determine as the image-and-sound processing proxy execution server 6 the external device which replies that the proxy execution is possible.

Alternatively, it may be possible to request a search server outside of image-and-sound processing device 1 to search for a server which will proxy-execute the image-and-sound processing, and image-and-sound processing proxy execution server 6 may be determined by using an obtained search result (URL information of a candidate server). That is to say, configuration may be made such that the external search server holds a list similar to image-and-sound processing proxy execution candidate server list 1100, obtains from image-and-sound processing device 1 a content of the proxy process, for example, information on what kind of image processing (extraction of attribute) the proxy process is, inquires the candidate servers on the list whether such a process is possible, and sends to image-and-sound processing device 1 URL information of the candidate server which has replied that the proxy process was possible.

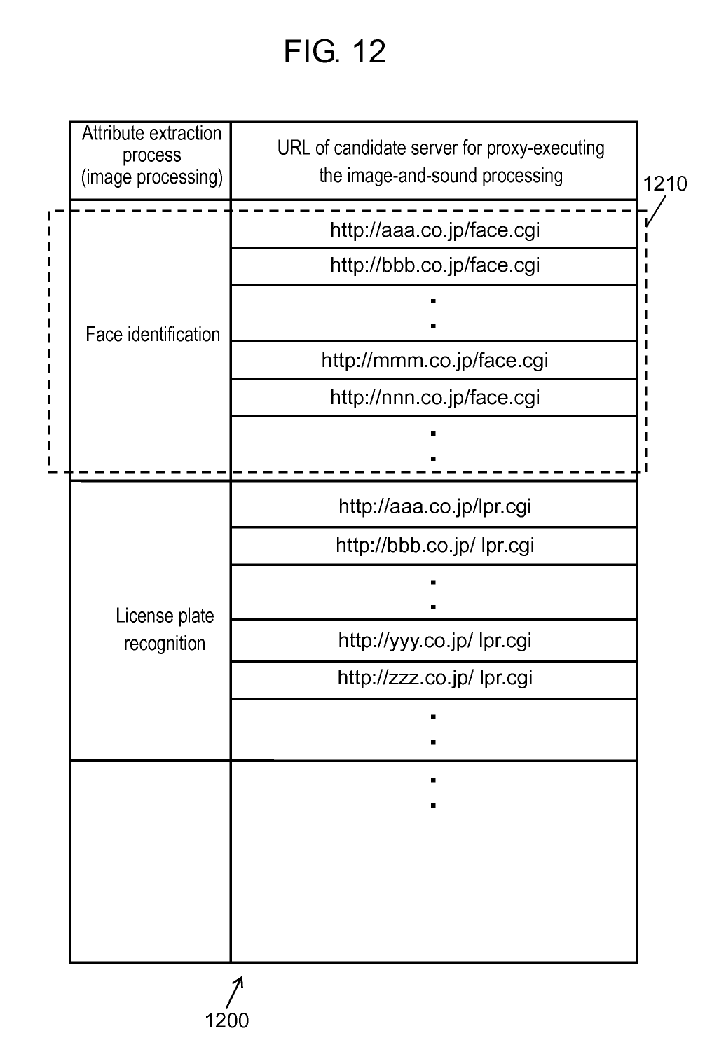

Further, image-and-sound processing device 1 may hold image-and-sound processing proxy execution candidate server list 1200, for example, as shown in FIG. 12, including a URL list of the candidate servers in which the proxy execution is possible for each image processing (each of the face recognition application, the license plate identification application, and the like). The difference between image-and-sound processing proxy execution candidate server list 1100 and image-and-sound processing proxy execution candidate server list 1200 is that image-and-sound processing proxy execution candidate server list 1200 holds the URL of the candidate server, for each image-and-sound processing, which proxy-executes the image-and-sound processing.

Configuration may be made such that image-and-sound processing device 1 inquires each candidate server sequentially from the top of the candidate server URL group which is in image-and-sound processing proxy execution candidate server list 1200 and corresponds to the currently targeted image processing whether the proxy execution is possible, and the candidate server which replies that the proxy execution is possible is determined as image-and-sound processing proxy execution server 6. For example, if the image processing is the face identification, image-and-sound processing device 1 first inquires the candidate server, having the URL (http://aaa.co.jp/face.cgi), of the candidate server URLs included in candidate server URL group 1210 whether the proxy process is possible, and if this candidate server is not capable of the proxy execution, image-and-sound processing device 1 next inquires the candidate server having the URL (http://bbb.co.jp/face.cgi) whether the proxy process is possible. Here, a selected image-and-sound processing execution server is supposed to be image-and-sound processing proxy execution server 6.

Subsequently, main controller 100 notifies the request of the image processing to image-and-sound processing proxy execution server 6 determined in step S830 from communication unit 30 (step S840). At this time, not only the notification of the request but a parameter necessary for the image processing may be notified.

Finally, main controller 100 sets the encode parameter set E determined in step S820 on encoder 50 (step S850). Setting the determined encode parameter set on the encode, when the same image processing will be subsequently executed on a regular basis, for example, can omit time and effort for setting the parameter set, in the later processing.

FIG. 9 is a flowchart illustrating a flow of the determination of the encode parameter set.

For example, image-and-sound processing device 1 is instructed to obtain the image data from the external device through communication unit 30, to extract a specific attribute information from the image data, and then to obtain the extracted attribute data (not shown in the drawings).

First, main controller 100 instructs image obtaining unit 10 to obtain image data P (step S910).

Successively, main controller 100 instructs image-and-sound processor 70 to execute the image processing on the image data P obtained in step S910, and then obtains the extracted attribute data A as the image processing result (step S920).

Main controller 100 refers to correspondence table 1000 to select the encode parameter set corresponding to the image processing, and temporarily sets the selected encode parameter set EE on the encoder (step S930).

By using the temporarily set encode parameter set EE, the image data P is encoded to obtain encoded image data PEE (step S940).

Then, by decoding the encoded image data PEE, image data PD are obtained (step S950).

On image data PD, the image processing is executed to obtain extracted attribute data AD as the image processing result (step S960).

Then, main controller 100 compares the extracted attribute data A as the image processing result obtained in step S920 and the extracted attribute data AD as the image processing result obtained in step S960 (step S970). As a result of the comparison, if the two results are determined to be identical, the process goes to the next step; however, it is not determined that the two results are identical, the process goes back to step S930, and after temporarily setting a new encode parameter set EE, which have not been temporarily set so far, and then steps S930 to S970 are executed again. For example, if the type of image processing is the face identification, the image processing is executed by using encode parameter set 1030, that is to say (the image resolution, the transmission rate, . . . )=(VGA, 1000, . . . ), included in corresponding encode-parameter-set group 1010; and then, if it is not determined that the two results are identical, the image processing is executed by using different encode parameter set 1040, that is to say (the image resolution, the transmission rate, . . . )=(Full HD, 5000, . . . ).

The process of changing the encode parameter set and then executing the image processing is repeated until it is determined that the extracted attribute data A as the image processing result obtained in step S920 and the extracted attribute data AD as the image processing result obtained in step S960 are the same result. Note that in the case where the same extracted attribute data cannot be obtained even after the above comparison has been performed for all the encode parameter set, an error may be returned.

Finally, the main controller 100 sets the temporarily set encode parameter set EE on encoder 50 as the encode parameter set EE to be finally set (step S980).

Note that, in FIGS. 3 to 12, description is made on the example in which the image data is obtained and subjected to the image processing; however, if image data are replaced by sound data, and image processing is replaced by sound processing, the sound processing is possible.

### Other Modified Examples

As described above, the embodiment is described as an example of the technologies disclosed in the present application. However, the technologies of the present disclosure are not limited thereto, and the following cases are included in the present embodiment.

(1) The above-described devices may be a computer system specifically configured with a microprocessor, a ROM, a RAM, a hard disk unit, a display unit, a keyboard, a mouse, and the like. In the RAM or the hard disk unit, a computer program is stored. The microprocessor which is operating according to the computer program allows the devices to accomplish functions thereof. Here, the computer program is configured with a combination of a plurality of command codes for instructing the computer so that predetermined functions are accomplished.

(2) A part or the whole of components constituting each of the above-described devices may be configured with one system LSI (Large Scale Integration: large-scale integrated circuit). The system LSI is a super multifunction LSI which is manufactured by integrating a plurality of components on a chip, and is specifically a computer system configured to include a microprocessor, a ROM, a RAM, and the like. In the RAM, a computer program is stored. The microprocessor which is operating according to the computer program allows the system LSI to accomplish the function thereof.

(3) A part of or the whole of components constituting each of the above devices may be configured with an IC card detachable to the device or a single module. The IC card or the module is a computer system configured with a microprocessor, a ROM, a RAM, and the like. The IC card or the module may include the above-mentioned super multifunction LSI. The microprocessor which is operating according to the computer program allows the IC card or the module to accomplish the function thereof. The IC card or the module may be tamper proof.

(4) A processing device of the present embodiment may be methods described above. The processing device of the present embodiment may be a computer program for implementing these methods, or may be digital signals configured with a computer program.

The processing device of the present embodiment may be a computer readable recoding medium, for example, a flexible disk, a hard disc, a CD-ROM, an MO, a DVD, a DVD-ROM, a DVD-RAM, a BD (Blu-ray (registered trademark) Disc), a semiconductor memory, or the like in which a computer program or digital signals can be recorded. The processing device of the present embodiment may be digital signals recorded in these recoding media.

The processing device of the present embodiment may be a computer program or digital signals transferred through an electric communication line, a wireless or cable communication line, a network as represented by the Internet, a data broadcasting, or the like.

The processing device of the present embodiment may be a computer system equipped with a microprocessor and a memory, the memory may store the above-described computer program, and the microprocessor may operate according to the computer program.

The program or the digital signals may be recorded in a recoding medium to be transferred, or may be transferred through a network or the like, and may be then executed by another separate computer system.

(5) The above-mentioned embodiment and the above-mentioned modified examples may be combined.

The processing device of the present disclosure is useful for a device which can determine an appropriate parameter set to be used for a compression-encoding process and other devices, for example, a surveillance device.

What is claimed is:

1. A processing device comprising:
an encoder configured to compression-encode first uncompressed information, based on a first parameter set, to generate first compression-encoded information, and configured to output the first compression-encoded information;
a decoder configured to decode the first compression-encoded information to generate second uncompressed information, and configured to output the second uncompressed information;
an image-and-sound processor configured to execute an attribute extraction process on the first uncompressed information to extract attribute information, and then to output first extracted attribute data which is the extracted attribute information, and configured to execute the attribute extraction process on the second uncompressed information to extract attribute information, and then to output second extracted attribute data which is the extracted attribute information; and
a controller configured to determine, when the first extracted attribute data and the second extracted attribute data are identical, the first parameter set as an established parameter set.

2. The processing device according to claim 1,
wherein the established parameter set is determined after the controller estimates that the execution of the attribute extraction process uses a greater amount of the hardware resources of the processing device than a permitted maximum usage amount of the hardware resources.

3. The processing device according to claim 2,
wherein the attribute extraction processes is one of a plurality of attribute extraction processes,
wherein the image-and-sound processor holds a correspondence table which represents encode-parameter-set groups, each of a plurality of attribute extraction processes having a corresponding encode-parameter-set group that is one of the encode-parameter-set groups,
wherein each of the encode-parameter-set groups includes a plurality of encode parameter sets,
wherein each of the plurality of encode parameter sets includes one or more encode parameters, and
the plurality of encode parameter sets include the first parameter set.

4. The processing device according to claim 3,
wherein when the first extracted attribute data and the second extracted attribute data are not identical, the encoder compression-encodes the first uncompressed information to generate second compression-encoded information based on, instead of the first parameter set, a second parameter set which is one of a plurality of parameter sets included in the encode-parameter-set group corresponding to the attribute extraction process and which is a parameter set other than the first parameter set, and the encoder then outputs the second compression-encoded information,
wherein the decoder decodes the second compression-encoded information to generate third uncompressed information and outputs the third uncompressed information,
wherein the image-and-sound processor outputs third extracted attribute data which is attribute information extracted from the third uncompressed information, and
wherein the controller determines, when the first extracted attribute data and the third extracted attribute data are identical, the second parameter set as an established parameter set.

5. The processing device according to claim 4, comprising:
a proxy-execution-server determination unit,
wherein the proxy-execution-server determination unit holds a candidate list including a candidate server for an image-and-sound processing proxy server which executes, substituting for the processing device, the attribute extraction process on third compression-encoded information which is generated by compression-encoding fourth uncompressed information, based on the established parameter set;
the proxy-execution-server determination unit asks the candidate server included in the candidate list whether the attribute extraction process is possible; and
the processing device obtains the fourth uncompressed information after obtaining the first uncompressed information.

6. The processing device according to claim 4, wherein an external device which is a device other than the processing device holds a candidate list including a candidate server for an image-and-sound processing proxy server which executes, substituting for the processing device, the attribute extraction process on third compression-encoded information which is generated by compression-encoding fourth uncompressed information, based on the established parameter set;
the external device asks the candidate server included in the candidate list whether the attribute extraction process is possible; and
the processing device obtains the fourth uncompressed information after obtaining the first uncompressed information.

7. The processing device according to claim 5, wherein the candidate list includes pieces of candidate server information, each of the pieces of candidate server information corresponding to each of the plurality of attribute extraction processes; and
a candidate server identified by using the candidate server information is a candidate server for the image-and-sound processing proxy server which executes the corresponding attribute extraction process, substituting for the processing device.

8. The processing device according to claim 7, wherein the attribute extraction process is a face identification process;
the attribute information includes at least one of a sex and an age category; and
the first parameter set includes an image resolution.

9. An integrated circuit comprising:
an encoder configured to compression-encode first uncompressed information, based on a first parameter set, to generate first compression-encoded information, and configured to output the first compression-encoded information;
a decoder configured to non-compression-encode the first compression-encoded information to generate second uncompressed information, and configured to output the second uncompressed information;
an image-and-sound processor configured to execute an attribute extraction process on the first uncompressed information to extract attribute information, and then to output first extracted attribute data which is the extracted attribute information, and configured to execute the attribute extraction process on the second uncompressed information to extract attribute information, and then to output second extracted attribute data which is the extracted attribute information; and
a controller configured to determine, when the first extracted attribute data and the second extracted attribute data are identical, the first parameter set as an established parameter set.

10. A processing method comprising:
compression-encoding first uncompressed information, based on a first parameter set, to generate first compression-encoded information;
outputting the first compression-encoded information;
non-compression-encoding the first compression-encoded information to generate second uncompressed information;
outputting the second uncompressed information;
executing an attribute extraction process on the first uncompressed information to extract attribute information, and then outputting first extracted attribute data which is the extracted attribute information, and executing the attribute extraction process on the second uncompressed information to extract attribute information, and then outputting second extracted attribute data which is the extracted attribute information; and
determining, when the first extracted attribute data and the second extracted attribute data are identical, the first parameter set as an established parameter set.

11. A computer-readable non-transitory recording medium which stores a program for making a computer execute the processing method according to claim 10.
